(19) United States
(12) Patent Application Publication
(10) Pub. No.: US 2012/0143417 A1
(43) Pub. Date: Jun. 7, 2012

(54) SYSTEM FOR ERROR DETECTION OF HYBRID VEHICLE AND METHOD THEREOF

(75) Inventors: Tae Young Chung, Seoul (KR); Tae Hee Jung, Hwaseong (KR)

(73) Assignees: KIA MOTORS CORPORATION, Seoul (KR); HYUNDAI MOTOR COMPANY, Seoul (KR)

(21) Appl. No.: 13/172,210

(22) Filed: Jun. 29, 2011

(30) Foreign Application Priority Data
Dec. 1, 2010 (KR) 10-2010-0121624

(51) Int. Cl. G06F 7/00; B60W 10/08; B60W 20/00; B60W 10/06

(52) U.S. Cl. 701/22; 903/903

(57) ABSTRACT

The present invention relates to a failure diagnosis device of a hybrid vehicle that detects and diagnoses a failure of a power module of a motor control device of a hybrid vehicle, and a method thereof. More specifically, a failure diagnosis device of a hybrid vehicle, which is provided along with an engine and a motor as a power source, and a motor control device for controlling operating speed and torque of the motor according to driving demand, is provided. The motor control device may include a control portion that controls a phase transformation such that DC voltage of a battery is transformed to voltage/current having a variable frequency, a power module that is provided with power switch elements to perform the phase transformation by the control portion, and a diagnosis module that independently diagnoses the current of each phase that is outputted by the power module.

### CROSS-REFERENCE TO RELATED APPLICATION

This application claims priority to and the benefit of Korean Patent Application No. 10-2010-0121624 filed in the Korean Intellectual Property Office on Dec. 1, 2010, the entire contents of which are incorporated herein by reference.

### BACKGROUND OF THE INVENTION

(a) Field of the Invention

The present invention relates to a failure diagnosis device of a hybrid vehicle that detects and diagnoses a failure of a power module of a motor control device of a hybrid vehicle, and a method thereof.

(b) Description of the Related Art

Demand for an environmentally-friendly vehicle has increased by reinforcement of exhaust gas regulations and enhancement of fuel efficiency. As a result hybrid vehicles have been spotlighted as a realistic alternative.

The hybrid vehicle can be distinguished from a fuel cell vehicle and an electric vehicle in a narrow sense, and the hybrid vehicle in this specification can include a fuel cell vehicle and an electric vehicle in a broad sense and can designate a vehicle that has at least one high voltage battery and a motor that is operated by that battery.

In this hybrid vehicle, if a power module that transforms DC voltage of a battery to 3-phase AC voltage malfunctions, the moving vehicle cannot be controlled by a motor and the torque can fluctuate such that normal driving is impossible. When a malfunction of the power module occurs, if the malfunction is not diagnosed and the hybrid function is not stopped, the battery can be overcharged or over-discharged to a point which may incur damage to the hybrid system, and since the demand torque of a driver is not satisfied, the vehicle operation can be unstable as well.

In a conventional hybrid vehicle, for example if a switch of one of 3 phases of a power module malfunctions, it is diagnosed by interior hardware or by comparing wave forms between each phase. However, when the interior hardware is added in this conventional diagnosis method, a spare layout has to be prepared and thus the overall cost of the system can be impacted. Also, when the waveforms between two phases outputted by a power module are compared, a calculation load of a motor controller is typically increased to generate a load on a processor as well.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a failure diagnosis device for a hybrid vehicle which is able to separately diagnose each phase by using asymmetric characteristics of a failure phase without depending on hardware or another phase to do so.

The present invention provides a failure diagnosis device for a hybrid vehicle, which is provided with an engine and a motor as a power source, and a motor control device for controlling operating speed and torque of the motor according to driving demand. This motor control device may include a control portion that controls a phase transformation such that DC voltage of a battery is transformed to voltage/current having a variable frequency, a power module that is provided with power switch elements to perform the phase transformation by the control portion, and a diagnosis module that independently diagnoses the current of each phase that is outputted by the power module.

The diagnosis module may be configured to determine that the power module is malfunctioning and then output a failure flag and stop operating of the power module if at least one of phase currents that are outputted by the power module has a half wave of a sine wave and the duration thereof is longer than a predetermined time.

The diagnosis module according to an exemplary embodiment of the present invention may include a current measuring portion that measures current of each phase that is outputted by the module to operate the motor, a failure decision portion that independently analyzes the current of each phase that is transferred from the current measuring portion to perform failure diagnosis through asymmetrical extraction, a driving decision portion that selects one of a limp home mode or a normal mode according to a decision of the failure decision portion, and a driving operation portion that operates the limp home mode or the normal mode according to the decision of the driving decision portion.

The failure decision portion may include a first area calculation portion that squares each current having the sine wave that is transmitted from the current measuring portion to calculate a valid value, an area separation portion that separates positive and negative areas based on “0” for the current of each phase of which the valid value is calculated by the first area calculation portion to be transmitted, a second area calculation portion that respectively squares a positive area value and a negative area value that are separately transmitted from the area separation portion to calculate a valid value, an integration calculation portion that divides the valid value of the second area calculation portion with the valid value of the first area calculation portion to extract a result, an approximate value estimation portion that estimates whether the extracted result of the integration calculation portion is asymmetric or not, and a time measuring portion that determines whether a time that the asymmetric condition of the approximate value estimation portion is continued is longer than a predetermined value.

Thus, in one embodiment of the present invention the failure diagnosis device for a hybrid vehicle, according to an exemplary embodiment of the present invention may include a current measuring portion that measures each current of a sine wave form that is outputted by a power module, a first area calculation portion that squares the current that is measured by the current measuring portion to calculate a valid value, an area separation portion that separates positive and negative areas based on “0” for the current of each phase that the valid value is calculated by the first area calculation portion, a second area calculation portion that respectively squares a positive area and a negative area of the area separation portion to calculate a valid value, an integration calculation portion that divides the value of the second area calculation portion with the value of the first area calculation portion to extract a result, an approximate value estimation portion that estimates whether or not the result of the integration calculation portion is asymmetric based on “0”, and a time measuring portion that determines whether a time that the asymmetric condition of the approximate value estimation portion is continued is longer than a predetermined value, and outputs a failure flag if the asymmetric condition is continued longer than the predetermined value.

The present invention may also be embodied as a failure diagnosis method of a hybrid vehicle according to an exemplary embodiment of the present invention which may include measuring, by a controller, the current of each phase having a sine wave that is outputted from a power module to calculate a first valid value, separating positive and negative areas based on “0” for the current of each phase of which the first valid value is calculated to calculate each valid value of a positive area and a negative area, dividing each valid value of the positive area and the negative area with the first valid value to extract a result and estimates whether the result is asymmetric or not based on “0”, and outputting a failure flag and stopping operation of the power module if the extracted result is asymmetric and the condition is continued for a predetermined time.

In the illustrative embodiment of the present invention, it may be determined that an upper arm or a lower arm outputting the current of a pertinent phase is opened to malfunction, if the result is asymmetric and the condition is continued for a predetermined time.

Advantageously, the present invention allows the cost to be decreased without changing the design and adding hardware to secure price. Also, each phase that is outputted by the power module is separately diagnosed to render reliability to failure diagnosis and stability to driving.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is schematic diagram of a hybrid vehicle according to an exemplary embodiment of the present invention.

FIG. 2 is a detailed view of a power module in FIG. 1.

FIG. 3 is a detailed view of a diagnosis module in a failure diagnosis device of a hybrid vehicle according to an exemplary embodiment of the present invention.

FIG. 4 is a detailed view of a failure decision portion in FIG. 3.

FIG. 5 is a flowchart showing a failure diagnosis procedure of a hybrid vehicle according to an exemplary embodiment of the present invention.

FIG. 6 shows wave forms and timing of each phase for a failure diagnosis of a hybrid vehicle according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, in the following detailed description, only certain exemplary embodiments of the present invention have been shown and described, simply by way of illustration.

As those skilled in the art would realize, the described embodiments may be modified in various different ways, all without departing from the spirit or scope of the present invention, and the drawings and description are to be regarded as illustrative in nature and not restrictive.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

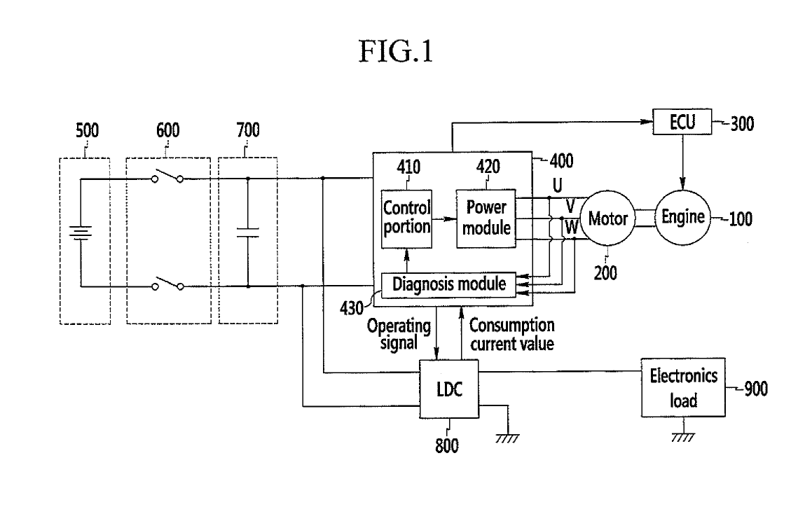

FIG. 1 is schematic diagram of a hybrid vehicle according to an exemplary embodiment of the present invention. As shown in FIG. 1, a hybrid vehicle includes an engine 100 as a first power source, a motor 200 as a second power source, an ECU (engine control unit) 300, an MCU (motor control unit) 400, a battery 500, a main relay 600, a capacitor 700, an LDC (low DC/DC converter) 800, and an electronic load 900.

The engine 100 outputs speed and torque by control of the ECU 300. The motor 200 is operated as a motor as well as a generator, the speed/torque thereof is controlled by the MCU 400, and the motor 200 charges the battery 500 via restoring braking energy through regenerative braking control.

A driving mode and an output torque of the engine 100 and the motor 200 are determined by driving conditions in order to realize maximum efficiency and other characteristics. The ECU 300 controls overall operations of the engine 100 according to control of a hybrid control device that is connected through a network to control output speed and output torque. The MCU 400 controls overall operations of the motor 200 according to control of a hybrid control device that is connected through a network to control driving speed and driving torque.

The battery 500 offers a voltage necessary to operate the motor 200 and uses a generated voltage to charge the battery 500. The main relay 600 regulates the input and output voltage of the battery 500 and the capacitor 700 stores a voltage that is supplied to the motor 200 from the battery 500 when the main relay 600 is in an “ON” state to sustain the voltage supplied to the motor 200. The LDC 800 transforms high voltage outputted from the battery 500 to low voltage that is necessary for the electronic devices to supply the electronic load 900 and simultaneously the auxiliary battery with the low voltage.

The electronic load 900 denotes all electronic devices and control apparatuses that are applied to the hybrid vehicle. For example, the electronic load could be a heater, air conditioner control or fans, power windows and locks, pumps etc.

The MCU 400 includes a control portion/process 410 that controls or executes a phase transformation operation of a power module 420 such that the DC voltage supplied from the battery 500 is transformed to be outputted as voltage and current having a variable frequency. The power module 420 consists of inverters that perform phase transformations by control of the control portion 410. Also within the MCU 400 is a diagnosis module 430 that independently analyses the current of each phase outputted from the power module 420 to determine whether the power module 420 is malfunctioning or not.

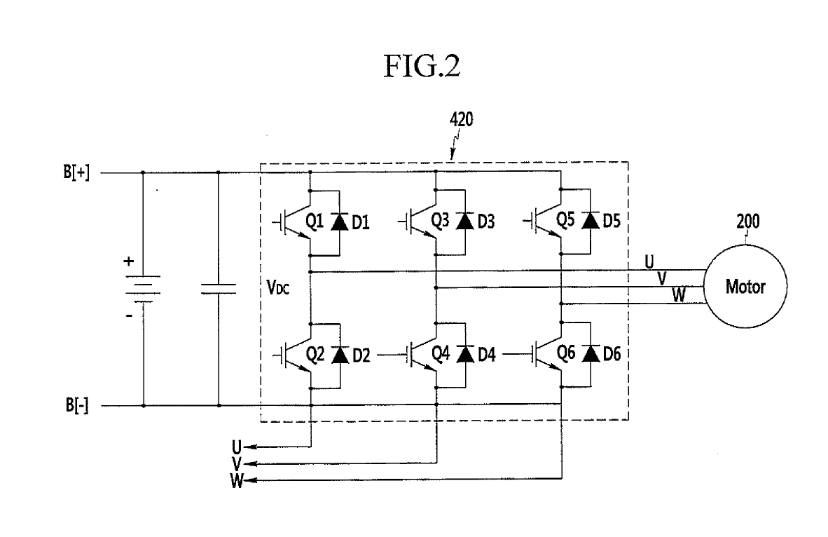

As seen in FIG. 2, the power module 420 generally consists of one pair of an upper arm and a lower arm, which consist of a total of three pairs, i.e. six power switch elements.

Accordingly, the upper arm consists of a first power switch element Q1, a third power switch element Q3, and a fifth power switch element Q5, and the lower arm consists of a second power switch element Q2, a fourth power switch element Q4, and a sixth power switch element Q6. A power switch element can be generally applied as a metal-oxide-semiconductor field-effect transistor (MOSFET) switch or an insulated gate bipolar transistor (IGBT) switch.

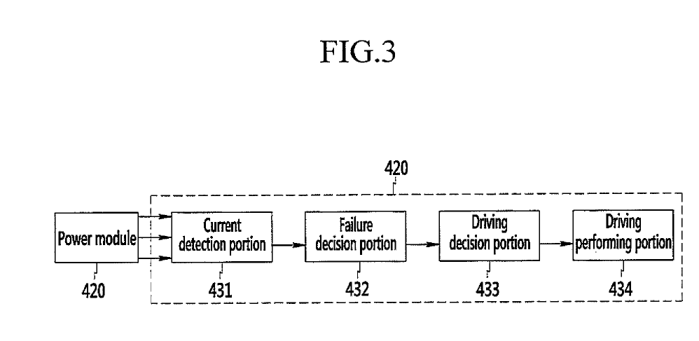

FIG. 3 is a detailed view of a diagnosis module in a failure diagnosis device of a hybrid vehicle according to an exemplary embodiment of the present invention. As shown in FIG. 3, the diagnosis module according to an exemplary embodiment of the present invention consists of a current measuring portion 431, a failure decision portion 432, a driving decision portion 433, and a driving operation portion 434. The current measuring portion 431 measures the current of each phase for operating the motor 200, which is outputted by the power module 420, to transfer the pertinent information to the failure decision portion 432. The failure decision portion 432 independently diagnoses the current of each U, V, W phase that is transmitted from the current measuring portion 431 to determine whether a phase having asymmetric feature is extracted or not, performs a failure diagnosis for each phase, and offers the result to the driving decision portion 433. The driving decision portion 433 determines whether a limp home mode is performed or a normal mode is performed according to the result of the failure decision portion 432 to transmit the result to the driving operation portion 434. The driving operation portion 434 performs the limp home mode or the normal mode according to the decision of the driving decision portion 433.

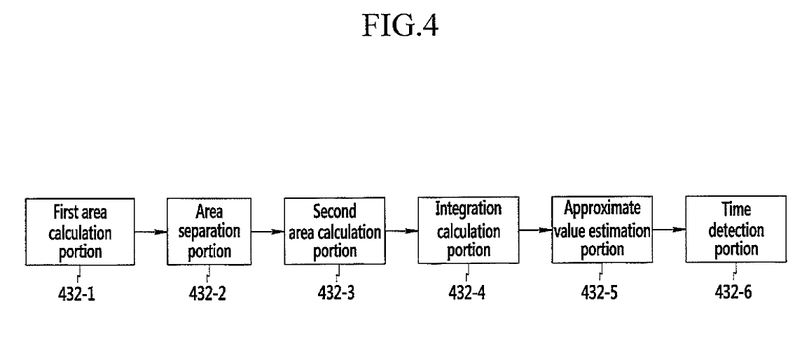

FIG. 4 is a detailed view of a failure decision portion in FIG. 3. As shown in FIG. 4, the failure decision portion 432 includes a first area calculation portion 432-1, an area separation portion 432-2, a second area calculation portion 432-3, an integration calculation portion 432-3, an approximate value estimation portion 432-4, and a time detection portion 432-6. The first area calculation portion 432-1 squares the current of each phase having a sine wave that is transmitted from the current measuring portion 431 to calculate a valid value, and transmits the calculated valid value to the area separation portion 432-2.

The area separation portion 432-2 separates a positive area and a negative area based on “0” for the current value of each phase of which the valid value is calculated to be transmitted. In this case, if the upper arm or the lower arm of one pair among the three pairs of power switch elements forming the power module 420 is opened to malfunction, a current having a half wave of a sine wave flows.

The second area calculation portion 432-3 respectively squares the positive area and the negative area that is divided in the area separation portion 432-2 to calculate a valid value and a difference thereof, and transmits the calculated valid value and the difference to the integration calculation portion 432-4. The integration calculation portion 432-4 divides the valid value that is calculated by the second area calculation portion 432-3 with the valid value that is calculated by the first area calculation portion 432-1 to transmit the result thereof to the approximate value estimation portion 432-5.

The approximate value estimation portion 432-5 determines whether the result that is extracted by the integration calculation portion 432-4 is asymmetric or not, e.g., if the result exceeds a predetermined value, for example 50%, and if it is determined that the result is asymmetric, transmits the result to the time measuring portion 432-6. The asymmetric condition is determined if an absolute value of a difference value between a square valid value of the positive area and a square valid value of the negative area in a phase current is larger than a square valid value of the sine wave current by a predetermined reference value. The reference value can be varied depending on conditions of a system or a vehicle.

The time detection portion 432-6 determines that the power switch element that outputs a phase current is malfunctioning if the asymmetric condition that is determined by the approximate value estimation portion continues for a predetermined time.

The operations of the present invention including the above configuration will be described as follows.

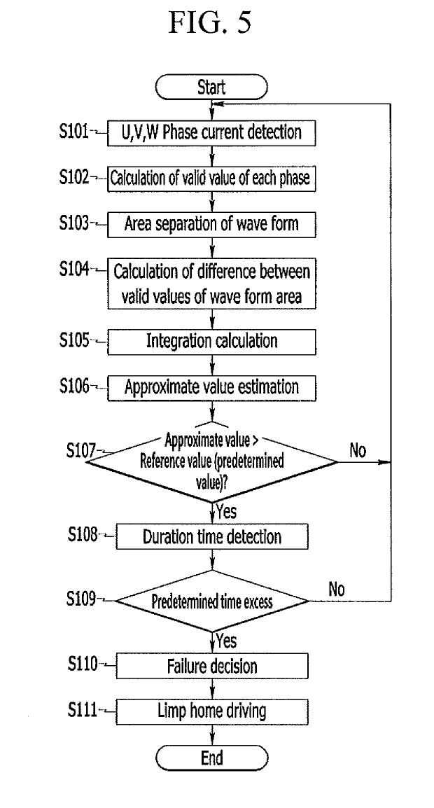

FIG. 5 is a flowchart showing a failure diagnosis procedure of a hybrid vehicle according to an exemplary embodiment of the present invention. The current measuring portion 431, that is disposed in the diagnosis module 430, functions when the hybrid vehicle of the present invention is being operated and measures current of each phase (U, V, and W) that is outputted by the power module 420 to be supplied to the motor 200 in S101.

The first area calculation portion 432-1 of a failure decision portion 432 squares each phase current of the sine wave that is supplied from the current measuring portion 431 to calculate a first valid value, and transmits the calculated valid value to the area separation portion 432-2 in S102.

The area separation portion 432-2 separates the positive area and the negative area based on “0” for the each phase current of which the first valid value is calculated to be transferred in S103. In this process, if an upper arm or a lower arm of one pair among three pairs of power switch elements forming the power module 420 is opened to malfunction, a current having a half wave of a sine wave flows. The second area calculation portion 432-3 respectively squares the positive area and the negative area that is divided in the area separation portion 432-2 to calculate a second valid value and a difference thereof, and transmits the calculated second valid value and the difference to the integration calculation portion 432-4 in 5104. The integration calculation portion 432-4 divides the second valid value that is calculated by the second area calculation portion 432-3 with the first valid value that is calculated by the first area calculation portion 432-1 to transmit the result thereof to the approximate value estimation portion 432-5 in S105.

The approximate value estimation portion 432-5 compares the extracted result of the integration calculation portion 432-4 with a predetermined reference value to estimate an approximate value in S106, and determines whether the estimated approximate value exceeds a reference value or not in S107. If the estimated approximated value exceeds a reference value, it is determined that it is asymmetric to transmit the result to the time detection portion 432-6. The asymmetric condition is determined if an absolute value of a difference value between a square valid value of the positive area and a square valid value of the negative area in a phase current is larger than a square valid value of the sine wave current by a predetermined reference value.

The time detection portion 432-6 measures a duration of the asymmetric condition that is determined by the approximate value estimation portion 432-5 in 5108, and determines whether the duration time exceeds a predetermined value in S109. If the asymmetric condition of the phase current is continued for a predetermined time in S109, it is determined that the power switch element that outputs the pertinent phase current is malfunctioning in S110. Hereafter, a limp home mode is performed through the driving operation portion 434.

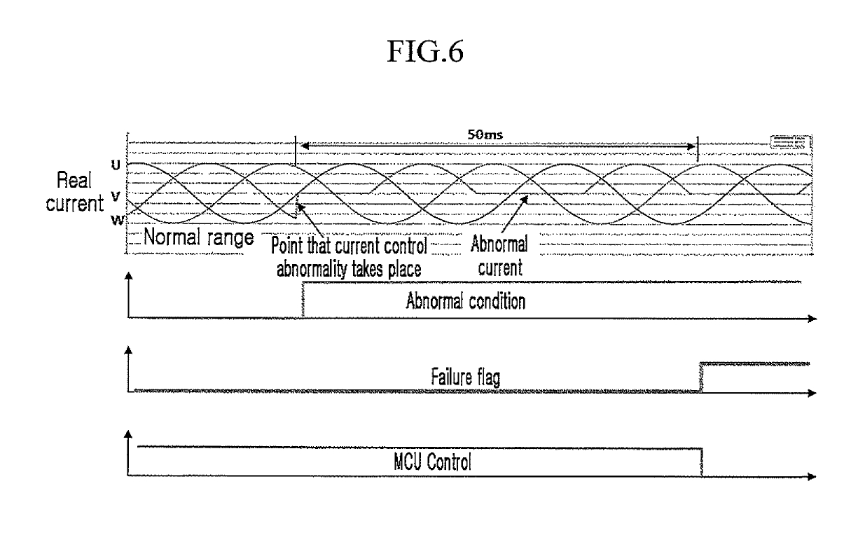

FIG. 6 shows wave forms and timing of each phase for failure diagnosis of a hybrid vehicle according to an exemplary embodiment of the present invention. As shown in FIG. 6, when each of the phases (U, V and W) of current that are outputted from the power module 420 are independently analyzed, if one of three pairs of power switch elements forming the power module 420, for example an upper arm or a lower arm of a power switch element outputting a W phase, is opened to be malfunctioning, a half wave current of a sine wave is turned on. Accordingly, if the half wave current of the sine wave is outputted to satisfy an abnormal condition, the duration is measured, and if the duration exceeds a predetermined time, for example 50 ms, it is determined that the power module 420 is malfunctioning to output a failure flag and a phase transformation operation of the power module 420 is halted.

Furthermore, the control mechanisms/portions of the present invention may be embodied as computer readable media on a computer readable medium containing executable program instructions executed by a processor. Examples of the computer readable mediums include, but are not limited to, ROM, RAM, compact disc (CD)-ROMs, magnetic tapes, floppy disks, and optical data storage devices. The computer readable recording medium can also be distributed in network coupled computer systems so that the computer readable media is stored and executed in a distributed fashion, e.g., wirelessly to a remote server.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

420: power module
430: diagnosis module
431: current measuring portion
432: failure decision portion
433: driving decision portion
434: driving operation portion

What is claimed is:

1. A failure diagnosis device of a hybrid vehicle, which is provided with an engine and a motor as a power source, and a motor control device for controlling operating speed and torque of the motor according to driving demand, wherein the motor control device includes:
a control portion that controls a phase transformation wherein DC voltage of a battery is transformed to voltage/current having a variable frequency;
a power module having a plurality of power switch elements configured to perform the phase transformation by the control portion; and
a diagnosis module that independently diagnoses current of the each phase that is outputted by the power module to determine whether the power module is malfunctioning.

2. The failure diagnosis device of claim 1, wherein the diagnosis module outputs a failure flag in response to determining that a power module is malfunctioning and stops operating the power module if at least one of phase currents that are outputted by the power module has a half wave of a sine wave and the duration thereof is longer than a predetermined time.

3. The failure diagnosis device of claim 1, wherein the diagnosis module includes:
a current measuring portion that measures current of each phase that is outputted by the module to operate the motor;
a failure decision portion that independently analyzes the current of each phase that is transferred from the current measuring portion to perform failure diagnosis through asymmetrical extraction;
a driving decision portion that selects one of a limp home mode or a normal mode according to a decision of the failure decision portion; and
a driving operation portion that operates the limp home mode or the normal mode according to the decision of the driving decision portion.

4. The failure diagnosis device of claim 3, wherein the failure decision portion includes:
a first area calculation portion that squares each current having the sine wave that is transmitted from the current measuring portion to calculate a first valid value;
an area separation portion that separates positive and negative areas based on “0” for the current of each phase of which the first valid value is calculated by the first area calculation portion to be transmitted;
a second area calculation portion that respectively squares a positive area value and a negative area value that are separately transmitted from the area separation portion to calculate a second valid value;
an integration calculation portion that divides the second valid value of the second area calculation portion with the first valid value of the first area calculation portion to extract a result;
an approximate value estimation portion that estimates whether the extracted result of the integration calculation portion is asymmetric or not; and
a time measuring portion that determines whether a time that the asymmetric condition of the approximate value estimation portion is continued is longer than a predetermined value.

5. The failure diagnosis device of a hybrid vehicle, comprising:
a current measuring portion that measures each current of a sine wave form that is outputted by a power module;
a first area calculation portion that squares the current that is measured by the current measuring portion to calculate a first valid value;
an area separation portion that separates positive and negative areas based on “0” for the current of each phase of which the first valid value is calculated by the first area calculation portion;
a second area calculation portion that respectively squares a positive area and a negative area of the area separation portion to calculate a second valid value;
an integration calculation portion that divides the second value of the second area calculation portion with the first value of the first area calculation portion to extract a result;
an approximate value estimation portion that estimates whether or not the result of the integration calculation portion is asymmetric based on “0”; and
a time measuring portion that determines whether a time that the asymmetric condition of the approximate value estimation portion is continued is longer than a predetermined value, and outputs a failure flag if the asymmetric condition is continued longer than the predetermined value.

6. A failure diagnosis method of a hybrid vehicle, comprising:
measuring, by a power module of a motor control unit, current of each phase having a sine wave that is outputted from a power module to calculate a first valid value;
separating positive and negative areas based on “0” for the current of each phase of which the first valid value is calculated to calculate valid values for each of a positive area and a negative area;
dividing each the valid values of the positive area and the negative area respectively with the first valid value to extract a result and estimate whether or not the result is asymmetric based on “0”; and
outputting a failure flag and stopping operation of the power module if the result is asymmetric and the condition continues for a predetermined time.

7. The failure diagnosis method of claim 6, wherein it is determined that an upper arm or a lower arm outputting a current of a pertinent phase is opened to malfunction if the result is asymmetric and the condition continues for a predetermined time.

8. A non-transitory computer readable medium containing executable program instructions executed by a processor to detect and diagnose a failure of a power module of a motor control device (MCU), comprising:
program instructions that measure current of each phase having a sine wave that is outputted from a power module to calculate a first valid value;
program instructions that separate positive and negative areas based on “0” for the current of each phase of which the first valid value is calculated to calculate valid values for each of a positive area and a negative area;
program instructions that divide each the valid values of the positive area and the negative area respectively with the first valid value to extract a result and estimate whether or not the result is asymmetric based on “0”; and
program instructions that output a failure flag and stopping operation of the power module if the result is asymmetric and the condition continues for a predetermined time.

9. The non-transitory computer readable medium of claim 8, wherein it is determined that an upper arm or a lower arm outputting a current of a pertinent phase is opened to malfunction if the result is asymmetric and the condition continues for a predetermined time.
